(19) United States
(12) Patent Application Publication
(10) Pub. No.: US 2014/0177812 A1
(43) Pub. Date: Jun. 26, 2014

(54) URGENT AND EMERGENCY NOTIFICATION AND COMMUNICATION SYSTEM

(71) Applicant: Richard Barrett, Rancho Santa Margarita, CA (US)

(72) Inventor: Richard Barrett, Rancho Santa Margarita, CA (US)

(21) Appl. No.: 14/136,620

(22) Filed: Dec. 20, 2013

Related U.S. Application Data
(60) Provisional application No. 61/745,455, filed on Dec. 21, 2012.

(51) Int. Cl. H04M 11/04; H04M 3/56

(52) U.S. Cl. CPC H04M 11/04; H04M 3/56
USPC 379/47

(57) ABSTRACT

A communication system for urgent and emergency notifications includes a commwunication device with sensors to obtain or determine user location information and/or status information following activation of the communication device. The communication device communicates over wireless and/or wired communication networks. In an urgent situation or an emergency, the communication device is activated and sends an alert to designated recipients, including the location and/or status information. The system also involves a repeated process of interrupting the recipients' communication devices to immediately notify the recipients of the urgency of the communication and to attempt to connect to the recipients. The system can also include the ability to record audio and/or video on the activating communication device and to transmit such recordings or files to designated recipients. The activated device can also send notification and connection attempts to emergency dispatchers.

### RELATED APPLICATIONS

This application claims the benefit of U.S. Provisional Patent Application No. 61/745455, filed Dec. 21, 2012, entitled “URGENT AND EMERGENCY NOTIFICATION AND COMMUNICATION SYSTEM,” which is hereby incorporated by reference herein in its entirety and for all purposes.

### BACKGROUND OF THE INVENTION

1. Field of the Invention

The present application is directed to urgent and emergency notification and communication and more particularly to urgent and emergency notification and communication via portable and stationary communication devices.

2. Description of the Related Art

The ubiquity of portable and stationary communication devices today has enabled people to stay in near constant communication with their friends and loved ones. For example, it is now possible to stay in contact via your home phone, BlackBerry, smart phone, mobile device, desktop computer, laptop computer, pager, personal digital assistant (PDA), tablet, and other electronic devices.

When an individual is busy, for instance, in a meeting, however, that individual may not think to check their portable communication devices, which may be on “vibrate” or “silent” mode, to see if any urgent messages have been received. For example, if an individual is waiting to hear from a family member as to the safe arrival of the family member at their intended destination, but the individual is so absorbed in the meeting that he does not notice the vibration of the phone with a text message or call, he or she may miss an urgent message or call regarding the status of the family member.

When an individual is in a serious accident, crime, or health emergency, the individual may not possess the faculties to initiate immediate contact on their existing communication devices. During a heart attack, for example, an individual's phone may be within an arm's reach, but that individual may not have the physical strength and motor skills required to activate their phone and dial 9-1-1, or find an application on their smart phone that accomplishes a similar task. In addition, an individual in that situation must make the choice at a critical moment between dialing either an emergency dispatcher or their friends and loved ones.

There is therefore a widespread need for an urgent and emergency notification and communication system to be installed on portable and/or stationary communication devices as an internally or externally located instrument to be used for urgent messages, emergencies, or life-threatening situations. The system can be particularly suited to easily initiate urgent alerts and facilitate communication with both close contacts and emergency responders. These alerts could be recognizable to the receivers of such communications that an urgent situation had occurred, enabling the receiver to act and react accordingly.

### SUMMARY OF THE INVENTION

The present application relates to methods and systems for initiating urgent contact, location tracking, status tracking, information recording, and dissemination of urgent information and data.

In accordance with one embodiment, the system includes a communication device; sensors to obtain user location information and/or status information following activation of the communication device; communication over wireless and/or wired communication networks; an alert sent to designated recipients; location and/or status information sent to the recipients; a repeated process of interrupting the recipients' communication devices to immediately notify the recipients of the urgency of the communication and to attempt to connect to the recipients; recording audio and/or video on the activating device; transmitting the information to designated recipients; and notification and connection attempts to emergency dispatchers.

In accordance with another embodiment, the system includes a process for pulling location information and/or status information from a recipient. In one embodiment, the user automatically receives the location and/or status information of the recipient upon activating the request. Once the location or status information has been sent to the requester, the system can inform the recipient of the request for data. In another embodiment, the recipient must authenticate the request before such information is obtained and sent to the requester.

In accordance with another embodiment, the user designates outgoing and incoming contacts for use with the system prior to activation of the system. Outgoing designated contacts are those contacts that the system will attempt to reach upon activation. Incoming designated contacts are those contacts in which the system can allow a user's device to be preempted. In yet another embodiment, the user can initiate the system without designating contacts. In such an arrangement wherein the user elects to not designate all or any contacts, the user can provide a recipient a pre-selected password that the recipient may use to contact the user in the event the recipient initiates an urgent or emergency communication with the user.

### BRIEF DESCRIPTION OF THE DRAWINGS

FIG. 1 is a graphical depiction of one preferred embodiment of user device interface interacting through communication networks to communicate with emergency responders and/or outgoing and/or incoming designated contacts on an urgent or emergency notification system.

FIG. 2 is a schematic drawing of one preferred embodiment of activating, notifying and/or contacting emergency responders and/or designated recipients on an urgent or emergency communication system.

FIG. 3 shows a schematic drawing of one preferred embodiment of activating and requesting location and/or status data from a target recipient on an urgent or emergency communication system.

FIG. 4 shows a schematic drawing of one preferred embodiment of an urgent or emergency communication system on a mobile device network.

### DETAILED DESCRIPTION OF THE PREFERRED EMBODIMENT

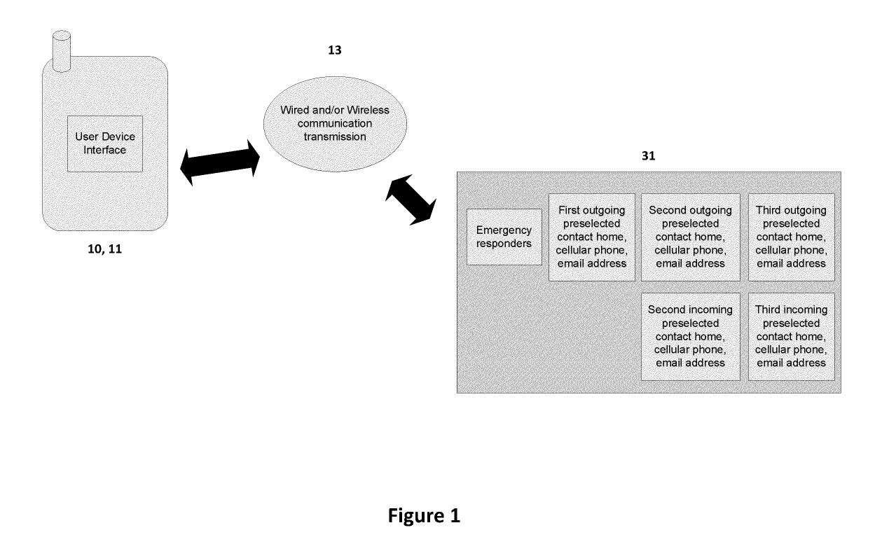

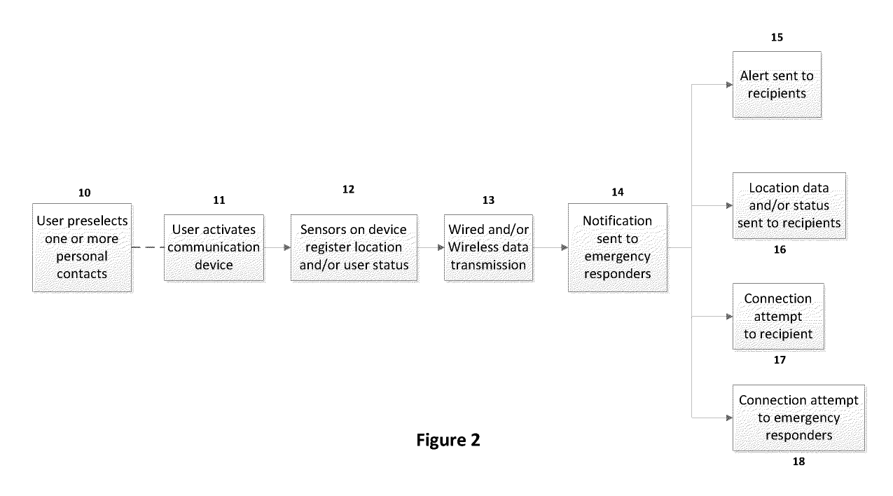

One embodiment described herein includes a system for initiating urgent and emergency communication to personal contacts and emergency responders. FIGS. 1 and 2 illustrate a graphical depiction and schematic drawing for initiating such communications, respectively. The system can include a software application on a portable communication device, for example a smartphone, PDA, or tablet, which can allow the user to designate one or more personal contacts 10 for use with the system during urgent and emergency communications. In other arrangements, the system can include such an application on a stationary communication device, such as a desktop computer, home telephone, television with internet, hardline or cell phone connectivity, or other communication devices as is known to those of skill in the art. In other embodiments, the user can either forgo or bypass the use of designated contacts 10 and can elect to initiate communications via a telephone number, email address, recipient from the user's contact list or other identifying communication marker at the time that the user activates urgent or emergency communication 11. In yet another embodiment, the user can initiate the system 11 without designating contacts. In one implementation without designating contacts on, for example, a cellular phone, the user could provide a preapproved list of contacts with their wireless carrier. In another arrangement, wherein the user can elect to not designate all or any contacts, the user can provide a recipient a pre-selected password that the recipient may use to contact the user in the event the recipient initiates an urgent or emergency communication with the user.

In one embodiment, the designated contacts can be organized as outgoing designated contacts and incoming designated contacts. With reference to FIG. 2, outgoing designated contacts, those contacts in which the system can attempt to alert of an emergency 15, send location and/or status information 16, and/or establish a connection to 17 upon activation of the system, can be sorted by order of preference. The user can select the order in which the contacts can be notified 15, sent location and/or status information 16, and/or connected to 17 when the system is activated. In some embodiments, the user can select the option to alert one or more contacts of an emergency 15, send location and/or status data 16 to one or more contacts, initiate communication 17 with one or more contacts, or some combination thereof. The user can, for example, initiate a connection with one contact 17 and notify more than one contact of the user's emergency 15, location 16, and physical status 16. The user interface can allow the user the option to select whether one or more than one of the outgoing contacts will be contacted either sequentially and/or simultaneously upon activation of the communication system.

Incoming designated contacts, those contacts in which the system can allow a user's device to be preempted, can be separately sorted by order of preference. In one embodiment, the user interface can allow the user to select which functionality of the device may be preempted upon receipt of a communication from an incoming designated contact. For a cellular telephone or smart phone, for example, such preemption can include interrupting an existing phone call 24, changing the volume of the audio alert or current ringtone or buzzer setting 27, and changing the intensity of the vibrate feature of the phone if the phone is set to silent or vibrate mode. The application can also allow the user to select personalized and individualized alerts for each incoming designated contact, or the user can alternatively leave the alert on a default alert style.

With reference to FIG. 2, the user can initiate urgent and emergency communication 11 or notification of designated contacts 10, 15, 16, 17 and/or emergency personnel 14, 18 by pressing a button or switch on an external enclosure; pressing existing buttons on a communication device; via an application on a communication device such as a computer program or smartphone application; by activating a communication device's voice features; automatically by sensor signals such as accident detection through accelerometer spikes; automatically upon attempting to contact emergency authorities; automatically upon a change in a body monitoring sensor such as a heart rate sensor; a via vehicle communications means; through GPS or subscription-based in-vehicle communications; or through other forms of activating electronic devices as is known in the state of the art. Activation can also occur through a combination of more than one of the above reference methods. Activation by multiple different methods can be necessary as urgent and emergency situations demand immediate and convenient methods for seeking assistance. In a crisis, emergency, or urgent situation, the user may not possess the physical and/or mental capacity to initiate urgent communications, such as the ability to utilize their limbs to reach their communication devices, use their eyes to see the device, or use their voice to initiate voice activation. In the case of injury, for example, a user's portable communication device may be within reach, however, the user may be trapped and unable to physically grip their device. It is in this situation that a user may benefit most from a sensor signal or accident detection initiation system

Upon activating the system 11, in some embodiments, the communication device can include or be coupled with sensors 12 to track and automatically or manually send the device's location information 16 to the intended recipients as shown in FIG. 2. The device triangulates its location and transmits that location to the selected recipient. In some embodiments, the location information can be obtained using existing sensors built into the device. In other embodiments, the location information can be obtained using sensors that are external to the device. Location can be determined by a different method depending on the type of device the user is employing, the available sensors, and the electronic communication networks that are in range of the device. The location information may include global positioning system (GPS) location information if the device has GPS hardware and/or software; the closest wireless tower information if the device is connected to a wireless cell-phone tower; and the IP address if the device is connected to a Wi-Fi network.

In one arrangement, the user can set presets or add tags for known locations. For example, using an application on a smartphone, the user can manually or automatically associate the IP address of their home network with the system such that upon activation of the communication device, any location data that includes the home network IP address can be sent with a user generated tag. The user can also associate GPS data to known locations and the closest cell tower with known locations. Such association can occur manually or automatically through the use of an electronic address book. In another embodiment, the system can associate tags through the use of an internal or external map program, for example the Google maps or Google earth application built into smartphones. Such a system could use Google maps, for example, to send information that the closest cell phone tower is adjacent to an airport, hospital, or police station.

With reference to FIG. 2, upon activating the system 11, in some embodiments, the communication device can include or be coupled with sensors 12 to track and automatically or manually send the user's status information 16 to the intended recipients. Such information can include vital telemetry data such as heart rate, respiratory rate, temperature and blood pressure. In some embodiments, the status information can be obtained using existing sensors built into the device, for example an on-board temperature sensor. In other embodiments, the status information can be obtained using sensors that are external to the device, such as a heart rate monitor.

As depicted in FIG. 2, one arrangement of using the system comprises sending location or status data to recipients 16 without attempting to alert the recipient of an emergency 15 or connect to the recipient 17. Such an arrangement can be used, for example, to urgently notify a recipient that a friend or loved one has arrived safely at a location. Such an arrangement can also be used to send physical telemetry data to a physician's office. In another embodiment, the device can intermittently or continuously obtain and/or send the user's location or status data to a recipient. Such an arrangement can be used to notify and update the recipient that the user has arrived home from school, or is delayed for an urgent meeting, for example by being stuck in traffic. Such an arrangement can also be used to send physical telemetry data to the user's primary physician once a day. In yet another embodiment, location and/or status data can be programmed to be obtained, sent, and/or repeated at a specific time, at a specified rate, frequency, duty cycle, or at a set interval. In some embodiments, location and/or status data can be programmed to be obtained and/or sent only when the user's location or status has changed or when the user's location and/or status is fluctuating at a specified minimum or maximum rate. Such a program can be used to limit the amount of data transmissions such that the recipient is only notified in the event of an important change, such as a spike in blood pressure. Limiting the amount of data transmissions can also be used to conserve the battery life of portable devices. As is known in the art, low duty cycling of wireless transmissions can reduce the power demand of a portable device, preserve onboard battery power, and reduce the need for frequent charging.

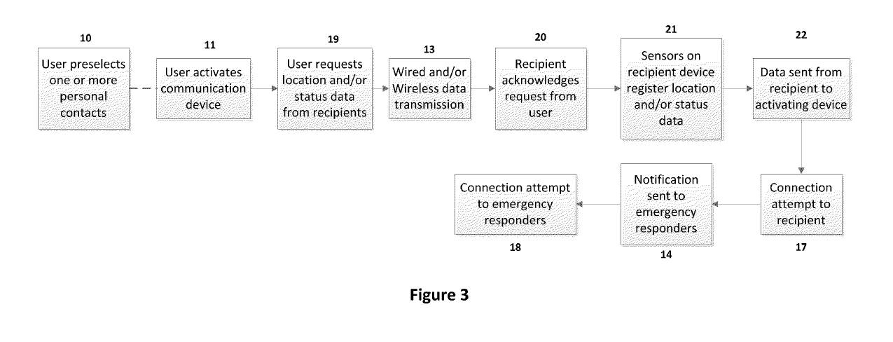

Another arrangement of using the system comprises pulling location information from one or more recipients 19 as depicted in FIG. 3. As opposed to sending location information in an emergency, this arrangement can allow a user to obtain location information of another party to ensure that the other party is not in an emergency. Such an arrangement can be used, for example, to request and receive notification that a friend or loved one has safely arrived at a location. For example, a parent in an important meeting can use the device to determine whether their child has safely arrived at the home from school, without having to ask and wait for a response. In one embodiment, the user automatically receives the location and/or status information 22 of the recipient upon activating the request 19. In some embodiments, once the location or status information has been sent to the requester 22, the system can inform the recipient of the request for data. In another embodiment, the recipient must authenticate 20 the request before such information is obtained 21 and sent to the requester 22. In such an embodiment, the recipient has the option of acknowledging and accepting the request 20 before location data or status data is obtained 21 and sent to the requester 22. In one embodiment, the user and/or recipient can designate 10 which contacts are authorized to pull their location information. In another embodiment, the recipient can optionally set a password for any user's attempt to retrieve location or status information.

In another arrangement (not illustrated), both the activating user's and the recipient(s)' devices could be used to send and obtain location information such that all parties' devices are sending and receiving location information. Such an arrangement could be used, for example, in a crowd location, to help each party locate one another, or to find a common meeting location. Such an arrangement could also be set to send alerts only when another device is coming nearby, or to send an alert when both devices are in the same location, for example, pinging the same nearest cell phone tower. Such an arrangement could also change the frequency of location requests depending on the proximity of the two devices.

FIG. 3 shows one embodiment of the process for requesting location and/or status data 19 from a recipient. In one embodiment, the user and/or recipients optionally designate 10 which contacts are authorized to retrieve location or status data on activation of the device. As discussed above, designation can occur through the use of an application on the device, or as an authorized contact on, for example, a wireless carrier when the device is a cellular telephone. In other embodiments, no designation occurs and access may be obtained by using a personal password associated with the recipient. Upon activation of the device, the user can send a request 19 for a recipient's location or status data to one or more recipients. In some embodiments, the location and/or status data of the user can also be obtained to be reciprocally transmitted to the recipient (not illustrated). The request can then be transmitted to the recipient's device through wired and/or wireless communication protocols 13 depending on the available communication network and the type of communication device. In some embodiments, the recipient has the option of accepting or denying the request from the user 20, as discussed above. In other embodiments, the request can be automatically granted, or the request can be confirmed by reference to the designated authorized user list. In yet other embodiments, the request may be authorized when the user enters in the recipient's password. Upon authorizing the request, sensors on the recipient device can register 21 location or status information and then send the information to the requesting user 22. In further embodiments, the user can attempt to connect to the recipient 17, if for example, the recipient's data cannot be transmitted or if the recipient is not at the proper location, and/or the user can send a notification to emergency responders 14 and attempt connect to emergency responders if desired 18.

FIG. 2 shows one embodiment wherein the user can activate the device to initiate urgent contact. As described above, the user can optionally designate one or more emergency contacts for use with the system 10. Upon activation 11, the user can attempt to initiate contact with their designated contacts 17, emergency responders 18, and/or other individuals not designated 17. Once activated, sensors can register 12 the user's location or status as described above. The location information or status information can then be transmitted 13 to emergency responders 14 and concurrently or simultaneously sent to designated recipients 16. In one arrangement, the device can send an alert 15, attempt to connect to one or more recipients 17 and/or send an alert 14 and connection attempt 18 to emergency responders. In other arrangements, the device can send location notifications or status notifications 14, 16 after connection to recipients 17 or emergency responders 18.

With respect to FIG. 2, the urgent message can be transmitted 13 by multiple transmission interfaces to ensure the recipients are timely alerted to the presence of an important communication. The sending mechanism can sequentially or simultaneously transmit the urgent message via a phone call to cellular telephone, a smartphone, or hardline phone; a phone video conference; a pager; a personal digital assistant; an SMS message; a BlackBerry message; an email; social networking sites such as Twitter or Facebook; instant messaging services; interruption to television sets through television video or voice calls; Skype; 911 emergency dispatch; or other communication devices and methods. The transmission can occur via one or more than one of the listed interfaces. The urgent message signal can be transmitted via wired and/or wireless communication networks 13 depending on the transmission protocols available and the type of sending and delivery devices.

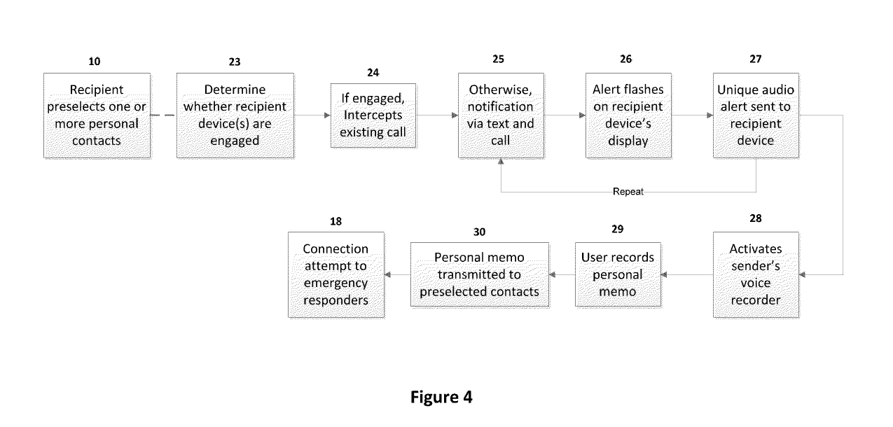

FIG. 4 illustrates one embodiment of the process of interrupting 24 and alerting 25 recipients of the urgent message on the recipient's telephone. A recipient receiving the urgent communication through a cellular or hardline telephone can be alerted by an interruption protocol. If the recipient's phone is engaged 24, the urgent message can assume priority and interrupt the current call, automatically placing the existing call on call-waiting with a default emergency message provided to the user on hold. If the recipient's phone is not engaged, a notification via SMS message, text, BlackBerry message, email and/or phone call can be sent to the recipient 25. If the recipient's phone is on vibrate mode or silent mode, the recipient's phone may be placed onto the loudest vibrate setting of the device or a unique buzzer setting may be specifically initiated upon receipt of an urgent message by the recipient's phone. If the recipient's phone is not on vibrate or silent mode, the ringer can be placed on the loudest setting with a unique identifiable ringtone alerting that an urgent communication is being transmitted 27. All ring settings can be accompanied by a distinctive flashing message on the recipient device's display 26. These processes can be repeated until either the recipient engages their phone or until a default time-out occurs. The purpose is to have such alerts noticeably different than any other form of messaging/calls incoming and to be universal in recognition of a crisis from the sender. Following termination of the urgent telephone call, the recipient's prior settings may be restored. If the recipient was engaged at the time the urgent message interrupted an existing telephone call, the existing call can be removed from call-waiting and the recipient can continue the existing telephone call. In one embodiment, if the transmission system cannot reach the recipients by, the system can initiate a personal voice and/or video recorder allowing the sender to create a personal recorded message to their intended recipients 28. After the message is recorded 29, the message can be transmitted to the recipients via one or more of the communication protocols described above 30.

In one embodiment, subsequent to failing to reach the intended recipients, the system may default to automatically alerting emergency dispatchers 18 as shown in FIG. 4. The system can transmit the location-tracking information or status information to local emergency dispatchers. The system can also automatically send an alert emergency dispatchers when the system is activated.

The various devices, methods, procedures, and techniques described above provide a number of ways to carry out the described embodiments and arrangements. Of course, it is to be understood that not necessarily all features, objectives or advantages described are required and/or achieved in accordance with any particular embodiment described herein. Also, although the invention has been disclosed in the context of certain embodiments, arrangements and examples, it will be understood by those skilled in the art that the invention extends beyond the specifically disclosed embodiments to other alternative embodiments, combinations, sub-combinations and/or uses and obvious modifications and equivalents thereof. Accordingly, the invention is not intended to be limited by the specific disclosures of the embodiments herein.

What is claimed is:

1. An urgent communication system comprising:
a mobile communication device;
a software application, wherein the application allows the user to associate one or more personal contacts for use upon activation of the system and to enter contact information of the personal contacts;
a command control unit having at least one sensor to activate the communication system; and
an alert protocol in the software application to obtain the attention of said personal contacts;
wherein the software application accesses the associated personal contacts and initiates communication with the associated personal contacts; and
wherein the alert protocol determines whether the personal contacts' device is engaged and overrides the engaged device to initiate communication.

2. The urgent communication system of claim 1, wherein the command control unit is voice activated.

3. The urgent communication system of claim 1, wherein the command control unit is activated by an actuator.

4. The urgent communication system of claim 1, wherein the communication device registers location information to be sent after activation of the communication system.

5. A method of initiating urgent communication on a communication network comprising:
associating at least one personal contact with a mobile communication device;
activating a mobile communication device to initiate communication with the associated personal contact; and
alerting the personal contact of an urgent communication.
